(19) United States
(12) Patent Application Publication
(10) Pub. No.: US 2011/0295640 A1
(43) Pub. Date: Dec. 1, 2011

(54) System and method for instant scheduling of resources among multiple parties with real-time confirmation

(76) Inventors: Edward P. Valentini, Jersey City, NJ (US); Michael McGrath, Brooklyn, NY (US)

(21) Appl. No.: 13/134,130

(22) Filed: May 31, 2011

Related U.S. Application Data
(60) Provisional application No. 61/349,823, filed on May 29, 2010.

(51) Int. Cl. G06Q 10/00

(52) U.S. Cl. 705/7.19; 705/7.13

(57) ABSTRACT

A schedule generating processor-implemented method is provided, whereby the method includes determining a plurality of resources for scheduling an event and extracting, from either one or more processor devices, manually entered data, or from a memory device, scheduling information corresponding to each of the determined plurality of resources. A list of available appointment time-slots are generated based on the extracted scheduling information corresponding to each of the selected plurality of resources. One or more scheduling time-slots are then generated from one or more overlapping time slots associated with the list of available appointment time-slots, whereby the generated one or more scheduling time-slots each include a start-time and an end-time determined from any adjacent overlapping appointment time-slots from among the generated list of available appointment time-slots.

### RELATED APPLICATIONS

Applicants hereby claim priority under 35 USC §119 from U.S. provisional patent application Ser. No. 61/349,823, filed May 29, 2010, entitled “INSTANT SCHEDULING OF RESOURCES AMONG MULTIPLE PARTIES WITH REAL-TIME CONFIRMATION,” the entire contents of the aforementioned application herein expressly incorporated by reference.

### FIELD

According to one embodiment, a system and method schedules resources and, more particularly, schedules resources in real-time among several parties over a variety of technologies, and exchanges confirmation messages between at least one of the parties.

### BACKGROUND

With an increased use of the internet and online tools for facilitating personal and professional tasks, a myriad of applications have been developed for managing and processing user-information or data.

### DRAWINGS

The accompanying drawings illustrate various non-limiting, example, inventive aspects in accordance with the present disclosure:

FIG. 1—shows a network diagram of servers in which an exemplary embodiment of the present invention is implemented;

FIG. 2—shows an exemplary embodiment of database tables needed to store scheduled appointment times for resources;

FIG. 3—shows how users may interact with the scheduling system according to one embodiment of the invention;

FIG. 4—depicts a programmatic interaction with the scheduler according to one embodiment of the invention;

FIG. 5—shows how the scheduling system determines available times given multiple resources and their dependent resources according to one embodiment of the invention; and

FIG. 6—shows how the system sends out real time confirmation of scheduled appointments over a variety of technologies.

### SUMMARY

According to at least one embodiment, a schedule generating processor-implemented method is provided. The method includes determining a plurality of resources for scheduling an event and extracting, from one or more processor devices (e.g., any device such as, for example, a PDA, smartphone, laptop computer, etc., which incorporates one or more processor devices operable to function as a CPU and/or configured to execute software, firmware, or any combination thereof). Information corresponding to each of the determined plurality of resources is then scheduled. A list of available appointment time-slots are generated based on the extracted scheduling information corresponding to each of the selected plurality of resources. One or more scheduling time-slots are then generated from one or more overlapping time slots associated with the list of available appointment time-slots, whereby the generated one or more scheduling time-slots each include a start-time and an end-time determined from any adjacent overlapping appointment time-slots from among the generated list of available appointment time-slots.

According to at least one other embodiment, a schedule generating processor-implemented method includes determining a plurality of resources for scheduling an event and extracting, from a memory device (e.g., a database), scheduling information corresponding to each of the determined plurality of resources. A list of ascending available appointment time-slots are generated based on the extracted scheduling information corresponding to each of the selected plurality of resources, whereby a first time-slot having a first start-time and a first end-time is selected from the list. A next time-slot having a next start-time and a next end-time is also selected from the list, where the selected next time-slot is an adjacent subsequent time-slot to the first time-slot. One or more scheduling time-slots are generated by merging the first time-slot and the next time-slot when the next start-time of the next time-slot is within a time range located between the first start-time and the first end-time of the first time-slot. Based on the merging, the generated one or more scheduling time-slots include the first start-time and the next end-time.

According to yet another embodiment, the one or more scheduling time-slots are generated by merging the first time-slot and the next time-slot when the next start-time of the next time-slot and the next end-time of the next time-slot are within the time range, whereby based on the merging, the generated one or more scheduling time-slots include the first start-time and the first end-time.

### DETAILED DESCRIPTION

The following provides a list of reference numerals used in the Figures and following description:
100—Database Server.
102—Application Server, which stores Scheduling System.
104—Internet.
106—Internet Browser running on Computer or Smartphone, or an application running on a smartphone to be used by user in order to interact with system.
107—Server or Apparatus having programmatic interaction with system.
108—Database Tables.
109—Scheduling Table.
110—Resource ID in the Scheduling table
112—Start Date and Time of appointment of resource.
114—End Date and Time of appointment of resource
115—Resource Dependency table.
116—Resource ID in the dependency table.
118—Resource ID of dependent resource
120—Consumer of resource logging into web service
122—Scheduling system searching for resources
124—Consumer selects which resources to schedule
126—System displays available times for selected resources
128—Divergence in flow depending on whether consumer is to choose time based on what is available or system is to choose time based on consumers availability and pre-established criteria.
130—Consumer chooses time from a list of available times.
132—System chooses time based on available times and criteria.
134—Consumer receives confirmation of appointment.
136—Producer of resource logging into web service.
138—Divergence in flow depending on whether producer manually enters resource, edits time availabilities for existing resources obtained through some other mechanism, or causes scheduling system to access producer's calendar and synchronize resources contained therein with those in the scheduling database.
140—Producer manually enters resource and dates and times of non-availability.
141—Producer selects resources, and enters times of non-availability for those.
142—System queries the busy info from the calendar of producer of resource.
144—Producer receives confirmation.
145—Client
146—Divergence in flow depending on whether consumer is to choose time based on what is available or server is to choose time based on consumers availability and pre-established criteria.
148—Client sends request to server to schedule given resources.
151—Client obtains availability times from calling entity
152—Client sends request to server to choose time automatically and confirm
154—Client receives list of available times from server
155—Client returns list of available times to calling entity
156—Client receives selected time from calling entity
158—Client sends request to server to confirm chosen time
160—Server receives request from client to schedule resources
162—Server determines if request is to return available times of resources or to choose time
164—Server checks availability of resources
166—Server sends client a message with list of available times.
168—Server chooses time of appointment
169—Server makes entry in database.
170—Server receives request to confirm chosen time.
171—Server sends confirmation of scheduled appointment.
172—System receives list of resources from calling entity
174—System searches resource dependency table and finds dependent resources.
176—System searches schedule table and determines busy times for resources determined in 174.
178—System sorts list in ascending order by date and time.
180—System examines first/next appointment in list
182—System determines if there are more appointments in list
184—System Examines next appointment in list.
186—System determines if start time of next appointment is earlier than end time of current appointment.
188—System determines if end time of next appointment is earlier than end time of current appointment
190—System deletes end time of next appointment and returns control to step 180.
192—System returns list of available times to calling entity.
194—If the answer to step 180 is no, advance to next appointment and go to step 180.
196—If the answer to step 190 is no, advance to next appointment and go to step 180.
198—System receives a time to schedule a given resource from calling entity
200—Server sends real time instant communication of confirmed appointment.
202—Server accesses users' calendar and inserts appointment into users' calendar directly.
204—Server sends SMS message alerting users of confirmed appointment
206—Server sends email to users alerting users of confirmed appointment.
208—Server sends instant message to users alerting users of confirmed appointment.
210—Server causes automated telephone call to be made to users alerting users of conformed appointment.

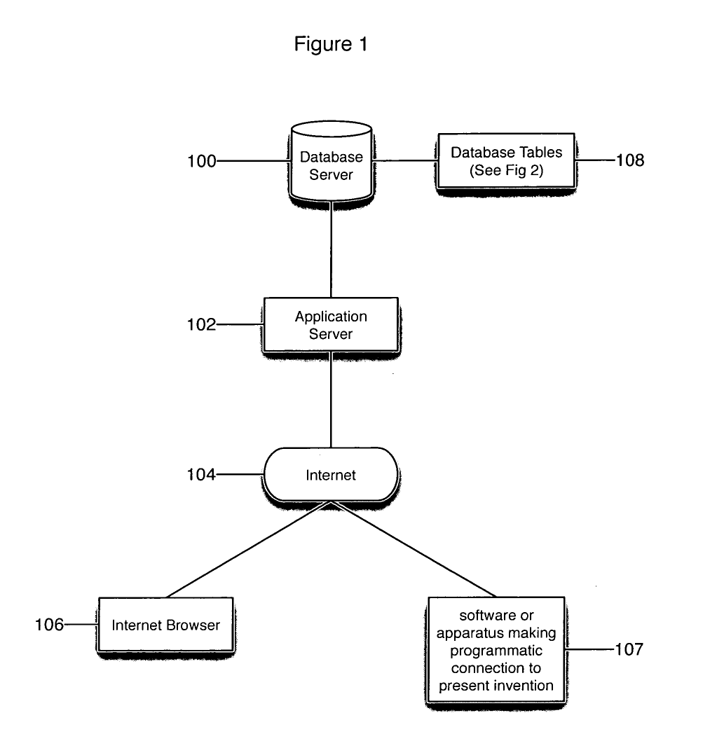

FIG. 1—Illustrates schematically a network diagram in which an embodiment of the present invention is implemented. The network is comprised of one or more database servers 100, which store the database scheduling tables 108, one or more application servers 102, which act as the liaison between the user or programmatic interface and the database servers 100 containing the scheduling databases. The system can be accessed by an electronic communication device 106 such as but not limited to a web browser on a workstation or from via PDA or smartphone over a communication channel such as but not limited to the internet. The system can also be accessed by one or more electronic communication devices using a programmatic interface 107.

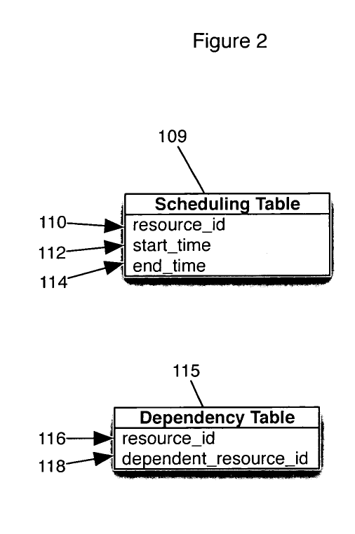

FIG. 2—Within the database server, the appointments are scheduled in a table 109 comprising at the very minimum, the fields start_time and end_time which hold the date and time as depicted in 112 and 114 respectively and some identifier (such as the resource id depicted in no). A second table 115 comprises a column 116 for resource identifiers and a second column 118 for dependent resource identifiers. There are times when the availability of a resource is governed by the availability of a dependent resource. For example, considering the situation where the present invention is implemented on a web site containing real estate listings, and is used to schedule showings of property between consumers and real estate brokers. Where a consumer wishes to schedule an appointment with a real estate broker to see a property, the availability/unavailability of the broker is dependent on the availability/unavailability of the property. Even if the broker is available, the property may not be available so the appointment cannot be scheduled. In the parlance of the present invention, the availability/unavailability of the broker is dependent on the availability/unavailability of the property.

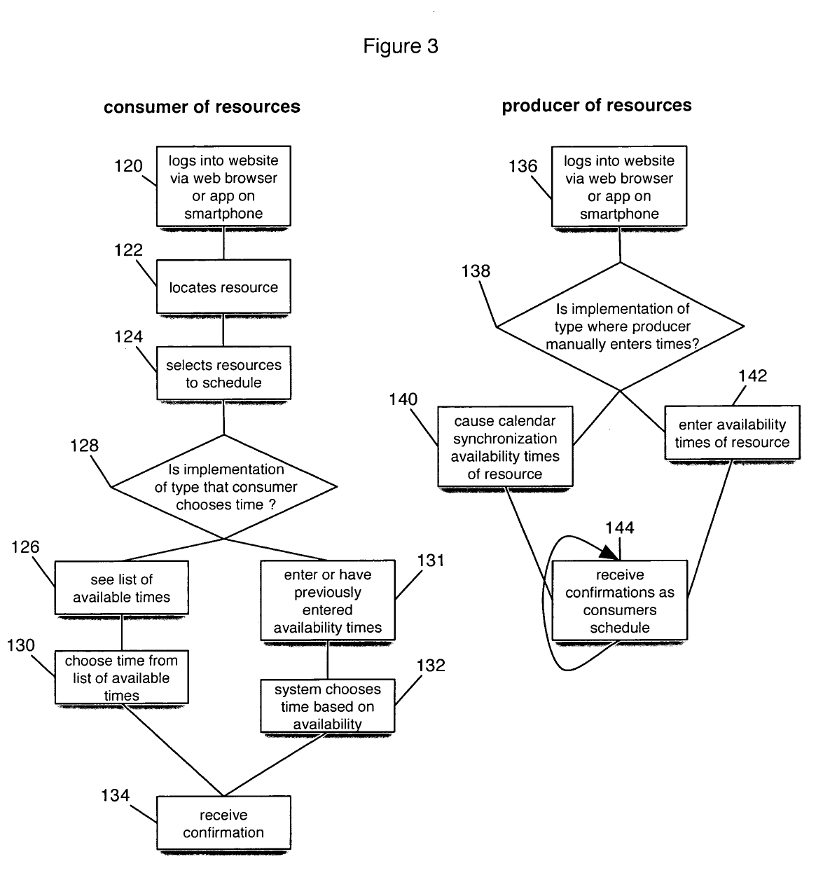

FIG. 3—shows how users interact with the scheduling system. The consumer of a resource or set of resources logs into the scheduling system 120 via web browser, or application on a smartphone, and searches the system 122 for resources to schedule. The consumer selects the resources he wishes to schedule 124 and then views a list of available times to choose from 126 on a display. There are at least two aspects associated with systems 128. For example, one that allows the consumer to choose from a list of available times, and another in which the scheduler chooses from the list of available times based on a preexisting criteria (e.g. first available time, first available time on Tuesday, last appointment of the workday, etc). If the system is of the type where the consumer is supposed to chose, then the consumer selects the appointment time from the list of available times 130, otherwise the system chooses a time that fits the availabilities and the preexisting criteria. Then the consumer receives instant confirmation of the appointment of the scheduled resource 134. Using the real estate example, if a consumer wishes to schedule a viewing of properties, the consumer would choose the properties he wishes to see and be presented with a list of availability times based on the availabilities of the property and the real estate broker. The consumer would select a time and receive instant confirmation of the appointment. In another embodiment, the consumer would not pick a time, but rather would enter (or have made available by allowing system to retrieve availability/unavailability times from his calendar) his availability/unavailability times and the system would choose an appointment time based on all the parties availabilities, the availability of the property and pre-existing criteria.

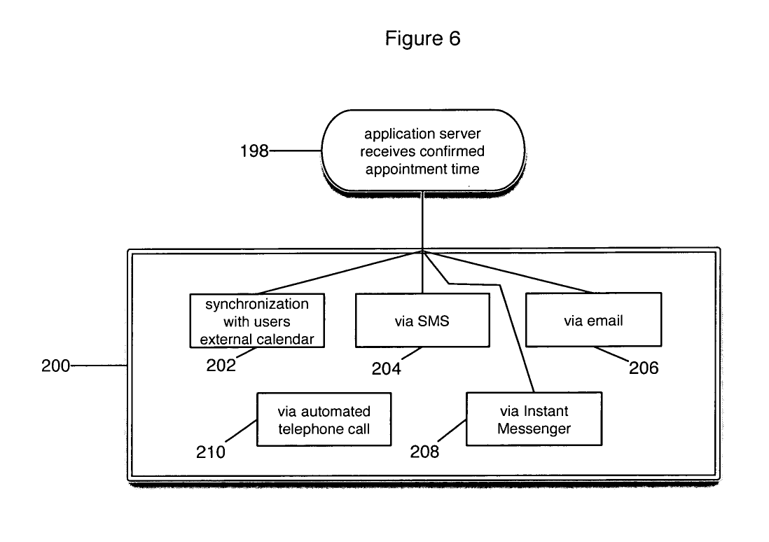

On the other hand, the producer of a resource or set of resources logs into the scheduling system 136 via web browser, or an application on a smartphone, and causes a resource to be entered into the system for scheduling. There are at least three aspects associated with systems 138. For example, one where the producer manually enters the resource to be scheduled 140, one where a description of the resource exists through some other mechanism and the producer need only edit the availability times of said resource 141, and another in which the producer already has the resources scheduled on another calendaring system and allows the instant scheduling system to retrieve the resources and their availability times from that calendaring system 142. Once the producer has entered or caused to be entered his resources into the system, he will receive instant notices of confirmation (See FIG. 6—200) as consumers schedule the resources. Turning once again to the real estate example, here, the producer is the real estate broker. In one embodiment the real estate broker would enter or cause to be entered availability/unavailability times for himself and for each property in the system. The method of entering the times could be a manual entry or the system could retrieve a list of available/unavailable times from an external calendar system. The present invention would retrieve those availability/unavailability times using known methods for interacting with those calendaring systems. Here, once consumers schedule appointments to view properties, the brokers would receive instant notifications of the appointments.

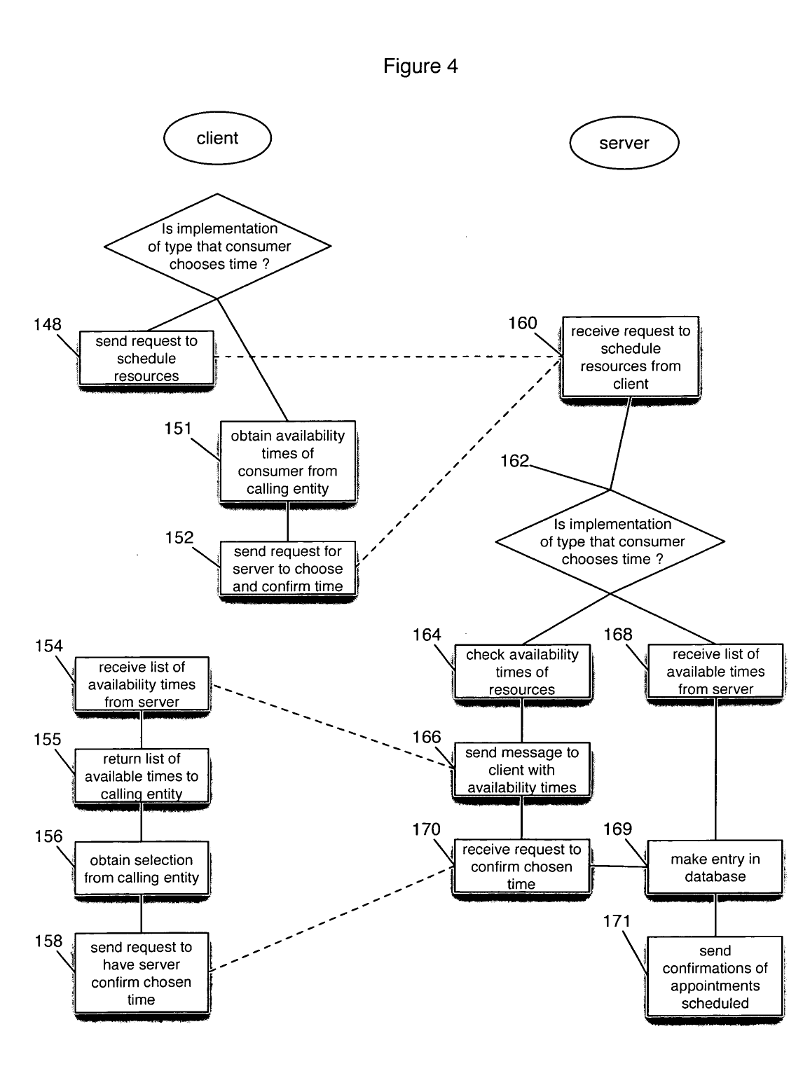

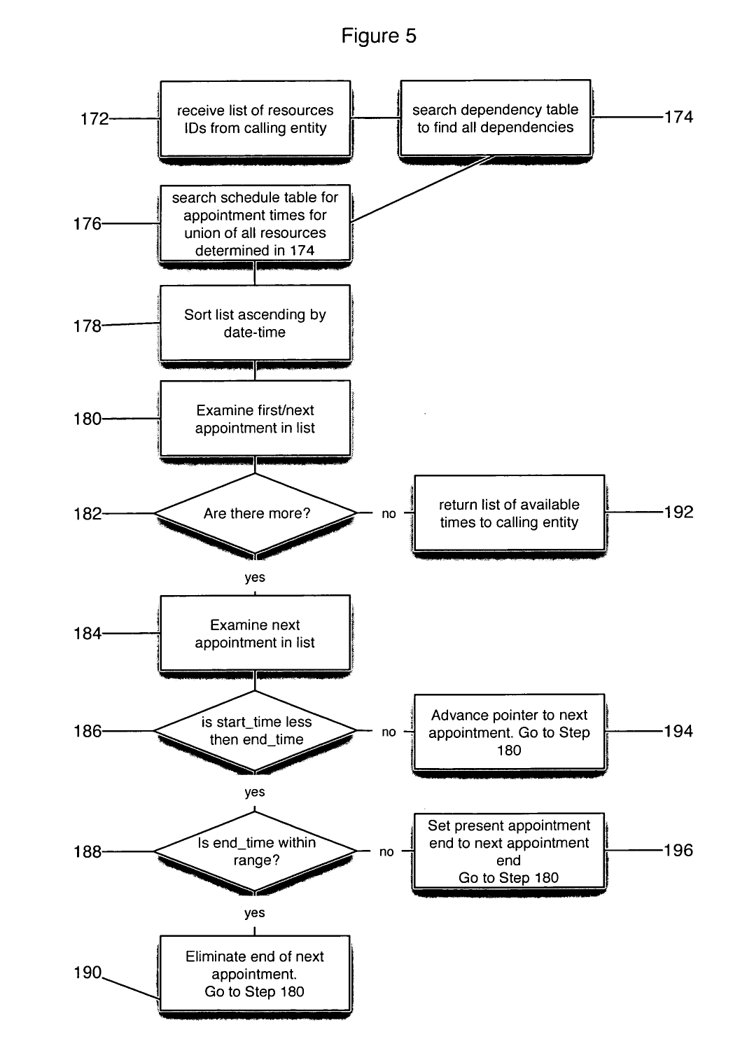

FIG. 4—Depicts an embodiment of a programmatic interaction with the scheduler. This embodiment comprises at least one client 145 and at least one server 159. The client means software that is running external to the application server, which endeavors to interact with the application server for the purpose scheduling a resource. If this particular implementation is the type, which requires the consumer to choose the time 146, the client sends a request (such as but not limited to an XMLHttpRequest) over a communication channel like the Internet to the server and includes in the request some reference to the resources it wishes to schedule 148. If on the other hand the implementation is of the type in which the consumer provides his availabilities/unavailabilities to the server and the server is to choose a time based on pre-existing criteria (such as: first available appointment, last available appointment of the day, etc. . . . ), the client obtains from the calling entity the list of the consumer's availabilities/unavailabilities 151 and then sends that list to the server 152. The application server receives the request from the client 160 and first determines the whether it is to choose a time based on receipt of the consumer's availabilities/unavailabilities or whether it is to check and return a list of available times to send back to the client so that the consumer can ultimately choose 162. If the server determines it is to return a list of availability/unavailability times for the requested resources, it checks the availabilities of these resources 164 using the method depicted in FIG. 5. The server then sends a message back to the client with the list of available times 166. The client receives the list of availability times 154. The client takes this list and returns it to the calling entity 155 so ultimately the consumer can choose a time, and then receives the choice back from the calling entity 156. At this point the client then sends a request back to the server 158 to confirm the chosen time and the server receives the request to confirm the chosen time 170.

If on the other hand, in 162, the server had determined that the consumer had supplied his availabilities to the server, and it was up to the server to choose a time based on pre-existing criteria, the server would choose a time 168 based on all the availabilities of the various resources and the pre-existing criteria.

Whether the client has supplied the time, or the server has chosen the time, now that the time is known, the server makes an entry 169 in the database table (See FIG. 2). The server then sends out instant confirmation 171 to all producers and consumers of the scheduled resource (See FIG. 6).

FIG. 5—depicts one embodiment of a method by which the scheduling system on the application server will determine availability times from a plurality of availability times as entered into the database table as in FIG. 2—109. In a given scheduling scenario, there are multiple resources that need to be scheduled, and those resources can in turn be dependent on other resources. In FIG. 5, the scheduler receives from the calling entity a list of references to resources to be scheduled 172. Here, a list of resource IDs would be passed (See FIG. 2—109,115). The scheduler then searches the resource dependency table of the database (FIG. 2—115) for all resources dependent on the resources passed to the scheduler 174. The scheduler then searches the schedule table for busy times 176 for all resources determined in step 174. The scheduler sorts the list of available times ascending by date and time 178. The system then loops through the list of availability times and looks at the first appointment 180. If there are no more appointments, then the routine is finished, and the list of available appointment times is returned to the calling entity. If there are more appointments, then the routine looks at the next appointment 180. If the start time of the next appointment is within the range of the current appointment being looked at 186, then the system checks if the end time of the next appointment is also within the range of the present appointment 188. If so, then the end time of the next appointment is deleted since it is superseded by the end time of the present appointment 190. If not then the end of the present appointment is set to the end of the next appointment 196. The counter is advanced to the next appointment and the loop continues at 180. If the start time of the next appointment is not in range, the counter is advanced to the next appointment, and this process is repeated until there are no more appointments left in the list 180. At the end of this procedure, there will be a sorted list of availability times, which can be presented to the calling entity. The calling entity can freely select from the list as it represents the intersection of the availability times of all the participating consumers and producers to the transaction. Once the calling entity selects an appointment time from the list of available times, several actions occur. An entry scheduling the given resources is made in the scheduling table of the database (FIG. 2—109). The appointment is either marked as busy for all parties involved or is deleted from the table of availability times (FIG. 2—109). This will vary depending on the specific implementation.

FIG. 6—All parties involved are sent a real time confirmation of the appointment. Real time confirmation includes but is not limited to one or more of the following methods: SMS, email, synchronization with user's external calendar (whether it be on PDA, or some other calendar system hosted on a server), instant message, or telephone call. Examples of external calendaring systems include Blackberry™, Outlook/Exchange Calendar™, Google Calendar™, or iCal™.

The embodiments of the invention are implemented as a web service accessible either via web browser or via application on a Smartphone, in which a human is interacting with the scheduling system. Alternatively, the scheduling system can be interacted with programmatically in which case third parties complying with a protocol can embed the scheduling functionality into their own software in order to connect with and make use of the scheduling system.

In one embodiment, producers will have access to the system in order to enter resources and consumers will have access to the system in order to schedule resources. Producers visit the web service and either enter resources and their availability times to be scheduled or enter availability times for resources already in the system obtained through some other mechanism. The consumer visits the website and searches for resources to schedule and then chooses a time based on the list of available times to be presented for the resources to be scheduled. The producers and consumer are all notified, instantly of the confirmation via electronic communication or telephone call.

In another embodiment, certain criteria are established by which the scheduling system chooses an available time based on certain preferences such as (first available appointment, last appointment of the day, first appointment after certain date, etc). Producers visit the web service and either enter resources and their availability times to be scheduled or enter availability times for resources already in the system obtained through some other mechanism. Consumers visit the web service and indicate their own availability times and which resources they would like to schedule. Once all parties to the transaction have finished entering their available times, the scheduler chooses from the list of available times, based on criteria that were established. All producers and consumers are instantly notified of the confirmation via electronic communication or telephone call.

The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition.

Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof.

As such, it should be understood that advantages, embodiments, examples, functional, features, logical, organizational, structural, topological, and/or other aspects of the disclosure are not to be considered limitations on the disclosure as defined by the claims or limitations on equivalents to the claims.

We claim:

1. A schedule generating processor-implemented method comprising:
determining a plurality of resources for scheduling an event;
extracting, from one or more processor devices, scheduling information corresponding to each of the determined plurality of resources;
generating a list of available appointment time-slots based on the extracted scheduling information corresponding to each of the selected plurality of resources; and
generating one or more scheduling time-slots from one or more overlapping time slots associated with the list of available appointment time-slots,
wherein the generated one or more scheduling time-slots each comprise a start-time and an end-time determined from any adjacent overlapping appointment time-slots from among the generated list of available appointment time-slots.

2. A schedule generating processor-implemented method comprising:
determining a plurality of resources for scheduling an event;
extracting, from a memory device, scheduling information corresponding to each of the determined plurality of resources;
generating a list of ascending available appointment time-slots based on the extracted scheduling information corresponding to each of the selected plurality of resources;
selecting a first time-slot from the list, wherein the first time-slot includes a first start-time and a first end-time.
selecting a next time-slot from the list, wherein the next time-slot includes a next start-time and a next end-time, the selected next time-slot being an adjacent subsequent time-slot to the first time-slot; and
generating one or more scheduling time-slots by merging the first time-slot and the next time-slot when the next start-time of the next time-slot is within a time range located between the first start-time and the first end-time of the first time-slot, wherein based on the merging the generated one or more scheduling time-slots comprise the first start-time and the next end-time.

3. The method according to claim 2, further comprising:
generating the one or more scheduling time-slots by merging the first time-slot and the next time-slot when the next start-time of the next time-slot and the next end-time of the next time-slot are within the time range, wherein based on the merging the generated one or more scheduling time-slots comprise the first start-time and the first end-time.

4. The method according to claim 3, wherein determining the plurality of resources for scheduling an event comprises:
receiving, from a resource, an appointment time request associated with the event; and
identifying at least one other resource associated with the received request, wherein the resource and the at least one other resource form the plurality of resources.

5. The method according to claim 4, further comprising:
displaying, in real-time, the one or more scheduling time-slots to the plurality of resources.

6. The method according to claim 5, wherein the plurality of resources comprise a real-estate broker and a real-estate property owner.

7. The method according to claim 5, wherein the plurality of resources comprise a real-estate broker, a property owner, and a real estate purchaser.

8. The method according to claim 5, further comprising:
selecting an appointment time-slot from the displayed one or more scheduling time-slots associated with the event.

9. The method according to claim 8, wherein the event comprises a showing of a real-estate property.

10. The method according to claim 8, wherein the event comprises a real-estate closing.

11. The method according to claim 8, further comprising:
sending, to the plurality of resources, a real-time confirmation message indicating the selected appointment time-slot.

12. The method according to claim 2, wherein the scheduling information corresponding to each of the determined plurality of resources is received from an electronic communication device associated with each of the determined plurality of resources.

13. The method according to claim 12, wherein the electronic communication device comprises at least one of a computer executing a web-browser, a personal digital assistant (PDA), and a smartphone.

14. The method according to claim 2, wherein the memory device includes a database comprising:
a scheduling table including:
a first resource identifier associated with each of the determined plurality of resources;
a time-slot start-time associated with the scheduling information associated with each of the determined plurality of resources; and
a time-slot end-time associated with the scheduling information associated with each of the determined plurality of resources.

15. The method according to claim 14, wherein the database comprises:
a dependency table including:
a second resource identifier associated with each of the determined plurality of resources, wherein the second resource identifiers maps to the first resource identifier in the scheduling table; and
a resource-dependent identifier indicative of determining the plurality of resources for scheduling the event.

16. The method according to claim 2, further comprising:
providing a graphical user interface that is accessible via a web-browser over a communication channel for:
receiving, from a resource, an appointment time request associated with the event;
identifying at least one other resource associated with the received request; and
displaying the one or more scheduling time-slots associated with the event.

17. The method according to claim 2, further comprising:
providing a graphical user interface that is accessible via a web-browser over a communication channel for:
receiving, from a resource, information associated with the event; and
identifying at least one other resource associated with the received event.

18. The method according to claim 17, wherein the information associated with the event comprises information corresponding to real-estate property that is being shown for sale.

19. The method according to claim 17, wherein the information associated with the event comprises information corresponding to a real-estate property closing.

20. A schedule generating system comprising:
a memory; and
a processor disposed in communication with the memory and configured to issue processing instructions stored in the memory to:
determine a plurality of resources for scheduling an event;
extract, from a memory device, scheduling information corresponding to each of the determined plurality of resources;
generate a list of ascending available appointment time-slots based on the extracted scheduling information corresponding to each of the selected plurality of resources;
select a first time-slot from the list, wherein the first time-slot includes a first start-time and a first end-time.
select a next time-slot from the list, wherein the next time-slot includes a next start-time and a next end-time, the selected next time-slot being an adjacent subsequent time-slot to the first time-slot; and
generate one or more scheduling time-slots by merging the first time-slot and the next time-slot when the next start-time of the next time-slot is within a time range located between the first start-time and the first end-time of the first time-slot, wherein based on the merging the generated one or more scheduling time-slots comprise the first start-time and the next end-time.

21. A processor-readable tangible medium storing processor-issuable schedule generating instructions to:
determine a plurality of resources for scheduling an event;
extract, from a memory device, scheduling information corresponding to each of the determined plurality of resources;
generate a list of ascending available appointment time-slots based on the extracted scheduling information corresponding to each of the selected plurality of resources;
select a first time-slot from the list, wherein the first time-slot includes a first start-time and a first end-time.
select a next time-slot from the list, wherein the next time-slot includes a next start-time and a next end-time, the selected next time-slot being an adjacent subsequent time-slot to the first time-slot; and
generate one or more scheduling time-slots by merging the first time-slot and the next time-slot when the next start-time of the next time-slot is within a time range located between the first start-time and the first end-time of the first time-slot, wherein based on the merging the generated one or more scheduling time-slots comprise the first start-time and the next end-time.

22. The method according to claim 1, wherein the plurality of resources comprise at least two of a real-estate broker, a property owner, a real estate purchaser, a real estate attorney, a mortgage broker, a home inspector, and an appraiser.
